(19) United States
(12) Patent Application Publication
(10) Pub. No.: US 2011/0215920 A1
(43) Pub. Date: Sep. 8, 2011

(54) ALARM PROCESSING METHOD, DEVICE, AND SYSTEM

(75) Inventors: Jian Zhu, Shanghai (CN); Kai Li, Shanghai (CN)

(73) Assignee: Huawei Technologies Co., Ltd., Shenzhen (CN)

(21) Appl. No.: 13/110,575

(22) Filed: May 18, 2011

Related U.S. Application Data
(63) Continuation of application No. PCT/CN2009/075019, filed on Nov. 18, 2009.

(30) Foreign Application Priority Data
Nov. 18, 2008 (CN) 200810217807.5

(51) Int. Cl. G08B 23/00

(52) U.S. Cl. 340/526

(57) ABSTRACT

An alarm processing method, device, and system are provided. Reported alarm information is received, alike alarm duration accumulation information in an appointed period is obtained from the reported alarm information, and an alarm notification is sent when the alike alarm duration accumulation information satisfies a report condition, so the method, device, and system can adapt to a failure mode with a characteristic of changing with time, filter valuable alarm information correctly and timely, and ensure stable operation of a communication equipment.

### CROSS-REFERENCE TO RELATED APPLICATIONS

This application is a continuation of International Application No. PCT/CN2009/075019, filed on Nov. 18, 2009, which claims priority to Chinese Patent Application No. 200810217807.5, filed on Nov. 18, 2008, both of which are hereby incorporated by reference in their entireties.

### FIELD OF THE INVENTION

The present invention relates to the field of communication technologies, and in particular, to an alarm processing method, device, and system.

### BACKGROUND OF THE INVENTION

An operation state of a communication equipment may be influenced by a hardware quality of the communication equipment, and is also susceptible to changes of the external environment. For example, factors such as power supply voltage, temperature, humidity, shaking, and electromagnetic interference may have influence on the communication equipment, so various failures may occur in the communication equipment. However, as a failure is unstable, detected failure information usually changes with time, and accordingly, a failure alarm also changes with time. A duration of a failure may be very short, or very long, a failure may occur a few times, or many times. For example, due to a connector failure, circuit board communication is thoroughly interrupted, so a circuit board may not be able to work normally. However, an inter-board communication alarm may frequently occur due to poor contact of connectors, thereby affecting the normal work of the circuit board, or even the circuit board might be unable to work at all.

The failure with a short duration is referred to as a transient failure, and the corresponding failure alarm is also referred to as a transient alarm. The failure occurring repetitively a plurality of times within a certain time and satisfying a certain rule is referred to as a toggle failure, and the corresponding alarm is also referred to as a toggle alarm. The transient and toggle alarms have a very short duration or may occur many times within a short time, which adversely influences monitoring of a communication network and reduces the efficiency of monitoring persons, so alarms need to be filtered, and it is judged whether an alarm is to be reported according to a value of an alarm for a user.

In the implementation of the present invention, the inventors find that, an alarm processing method in the prior art cannot solve the problem due to an alike alarm with a characteristic of changing with time, which results in that alike alarm information cannot be filtered and processed correctly, timely, and effectively, thereby causing the loss of valuable alarm information and even causing a hidden trouble.

### SUMMARY OF THE INVENTION

The present invention provide an alarm processing method, device, and system, which can filter valuable alarm information correctly and timely and ensure stable operation of an equipment.

In an aspect, an embodiment of the present invention provides an alarm processing method, where the method includes:

receiving alarm information reported when a failure is detected;

obtaining alike alarm duration accumulation information in an appointed period according to the received alarm information; and

sending an alarm notification when the alike alarm duration accumulation information in the appointed period satisfies a report condition.

In another aspect, an embodiment of the present invention further provides an alarm processing device, where the device includes:

a receiving unit, configured to receive reported alarm information;

an obtaining unit, configured to obtain alike alarm duration accumulation information in an appointed period according to the alarm information received by the receiving unit; and

a sending unit, configured to send an alarm notification when the alike alarm duration accumulation information in the appointed period obtained by the obtaining unit satisfies a report condition.

In another aspect, an embodiment of the present invention further provides an alarm processing system, where the system includes:

a failure detection device, configured to detect a failure and report alarm information to an alarm processing device when the failure is detected; and

an alarm processing device, configured to receive the reported alarm information, obtain alike alarm duration accumulation information in an appointed period according to the reported alarm information, and send an alarm notification when the alike alarm duration accumulation information in the appointed period satisfies a report condition.

Reported alarm information is received, alike alarm duration accumulation information in an appointed period is obtained from the reported alarm information, and an alarm notification is sent when the alike alarm duration accumulation information satisfies a report condition, so the alarm processing method, device, and system according to the embodiments of the present invention can adapt to a failure mode with a characteristic of changing with time, filter valuable alarm information correctly and timely, and ensure stable operation of a communication equipment.

### BRIEF DESCRIPTION OF THE DRAWINGS

To make the technical solution under the present invention clearer, the accompanying drawings for illustrating the embodiments of the present invention or the prior art are outlined below. Apparently, the accompanying drawings are for the exemplary purpose only, and person having ordinary skill in the art can derive other drawings from such accompanying drawings without creative efforts.

FIG. 1 is a flow chart of an alarm processing method according to an embodiment of the present invention;

FIG. 2 is a schematic view of an alarm processing method according to an embodiment of the present invention;

FIG. 3 is a first schematic structural view of an alarm processing device according to an embodiment of the present invention; and

FIG. 4 is a second schematic structural view of an alarm processing device according to an embodiment of the present invention.

### DETAILED DESCRIPTION OF THE EMBODIMENTS

Embodiments of the present invention are illustrated in detail hereinafter with reference to the accompanying drawings. Apparently, the embodiments described below are for the exemplary purpose only, without covering all embodiments of the present invention. Persons having ordinary skills in the art can derive other embodiments from the embodiments given herein without creative efforts, and all such embodiments are covered in the scope of the present invention.

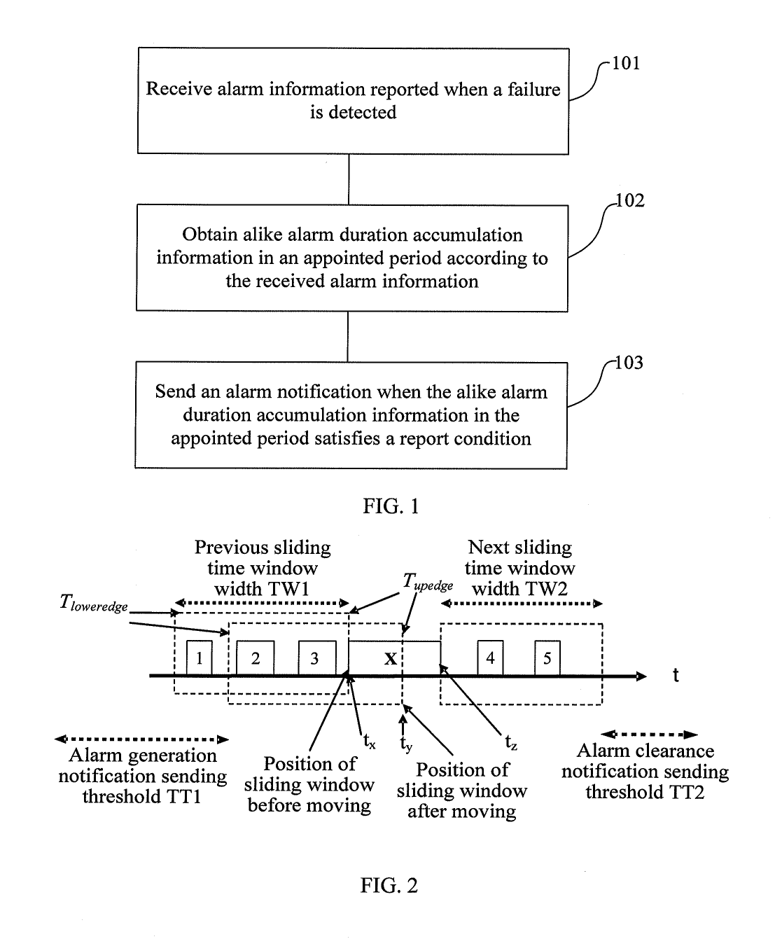

As shown in FIG. 1, an embodiment of the present invention provides an alarm processing method, including the following steps.

In step S101, alarm information reported when a failure is detected is received.

In step S102, alike al arm duration accumulation information in an appointed period is obtained according to the received alarm information.

In step S103, an alarm notification is sent when the alike alarm duration accumulation information in the appointed period satisfies a report condition.

By obtaining alike alarm duration accumulation information in an appointed period and sending an alarm notification when the alike alarm duration accumulation information satisfies a report condition, the alarm processing method according to the present invention enables the filtering of valuable alarm information correctly and timely and ensures stable operation of a communication equipment. Meanwhile, in the method according to the embodiment of the present invention, the alike alarm duration accumulation information in the appointed period is obtained, so the method may also effectively reduce the quantity of alarm information, and gain a very good balance between the quantity of alarms and correctness as well as timeliness of alarms.

The present invention provides another embodiment to illustrate the specific implementation of the alarm processing method in detail. The method includes the following steps.

1) A failure is detected and alarm information is reported.

A failure detection device performs failure detection on a communication equipment being detected, judges whether the communication equipment has a failure, judges attributes of the failure, and judges whether the failure needs to be reported. For example, the failure detection device may detect a failure in the following manners.

Manner 1, an active query manner, is as follows.

A state of the detected communication equipment is checked actively, that is, the failure detection device periodically detects a state of a communication port. When the state of the port is found unavailable and the state lasts a period of time, a failure alarm generation message of the port is reported; when this port changes from the unavailable state into an available state and the available state lasts a period of time, a failure alarm clearance message is reported.

Manner 2, an alarm data report manner, is as follows.

When signals received by the detected communication equipment at a receiving end of E1/T1 are all “1”, an Alarm Indication Signal (AIS, E1/T1) state is entered. When it is detected that a link enters the AIS state which lasts a period of time, AIS failure information is generated and reported to the failure detection device; when the link exits the AIS state which lasts a period of time, AIS failure recovery information is generated and reported to the failure detection device.

After the detection is completed, the failure detection device reports the detected failure alarm information to the alarm processing device.

2) The reported alarm information is received, and alike alarm duration accumulation information in an appointed period is obtained.

For an alike alarm each time, a duration from current alike alarm generation to current alike alarm clearance is referred to as a current alike alarm generation duration; a duration from current alike alarm clearance to next alike alarm generation is referred to as a current alike alarm clearance duration.

After the alarm processing device receives the alarm information reported by the failure detection device, the reported alarm information includes an alike alarm; the alarm processing device obtains the alike alarm duration accumulation information in the appointed period from the received alarm information. The alike alarm duration accumulation information in the appointed period may include a sum of all alike alarm generation durations occurring in the appointed period, may also include a sum of all alike alarm clearance durations occurring in the appointed period, and may also include a mathematical processing result of the sum of the alike alarm generation durations or clearance durations, and the mathematical processing includes normalized processing, extremum calculation or logarithm calculation, which is not limited in the embodiment of the present invention, as long as the mathematical processing result is also able to reflect the purpose of accumulating the durations. In this embodiment, zero or more alike alarm generation durations may exist.

3) It is judged, according to the obtained alike alarm duration accumulation information in the appointed period, whether the report condition is satisfied, and if the report condition is satisfied, an alarm notification is sent to other network equipments.

It is judged, according to the obtained alike alarm duration accumulation information in the appointed period, whether the report condition is satisfied, and if the report condition is satisfied, an alarm notification is sent to other network equipments such as other network elements, network element management systems or network management systems. Specifically, the following several cases may be included.

In Manner 1, the alike alarm duration accumulation information may be the alike alarm generation duration accumulation information in the appointed period, and the alike alarm generation duration accumulation information may be a sum of all alike alarm generation durations occurring in the appointed period, and may also be a mathematical processing result of the sum of all alike alarm generation durations occurring in the appointed period. When it is determined that the alike alarm generation duration accumulation information in the appointed period satisfies an alarm generation notification report condition, for example, the condition may be a threshold value, and the embodiment of the present invention does not limit a specific representation form of the report condition, an alarm generation notification is sent.

In Manner 2, the alike alarm duration accumulation information may also be the alike alarm clearance duration accumulation information in the appointed period, and the alike alarm clearance duration accumulation information may be a sum of all alike alarm clearance durations occurring in the appointed period, and may also be a mathematical processing result of the sum of all alike alarm clearance durations occurring in the appointed period. When it is determined that the alike alarm clearance duration accumulation information in the appointed period satisfies an alarm generation notification report condition, for example, the condition may be one threshold value, and may also be in other representation forms, the alarm generation notification is sent.

In Manner 3, the alike alarm duration accumulation information may be the alike alarm generation duration accumulation information in the appointed period, and the alike alarm generation duration accumulation information may be a sum of all alike alarm generation durations occurring in the appointed period, and may also be a mathematical processing result of the sum of all alike alarm generation durations occurring in the appointed period. When it is determined that the alike alarm generation duration accumulation information in the appointed period satisfies an alarm clearance notification report condition, for example, the condition may be one threshold value, and may also be in other representation forms, the alarm clearance notification is sent.

In Manner 4, the alike alarm duration accumulation information may also be the alike alarm clearance duration accumulation information in the appointed period, and the alike alarm clearance duration accumulation information may be a sum of all alike alarm clearance durations occurring in the appointed period, and may also be a mathematical processing result of a sum of all alike alarm clearance durations occurring in the appointed period. When it is determined that the alike alarm clearance duration accumulation information in the appointed period satisfies an alarm clearance notification report condition, for example, the condition may be one threshold value, and may also be in other representation forms, the alarm clearance notification is sent.

The appointed period according to this embodiment may be a default value, and may also be manually set, and a start time and an end time of the appointed period may also be dynamically changed.

For convenience of illustration, the appointed period which may be dynamically changed may be referred to as a sliding time window. A sliding time window used for judging whether to send an alarm generation notification is referred to as a previous sliding time window; a sliding time window for judging whether to send an alarm clearance notification is referred to as a next sliding time window.

The specific implementation of Manners 1 and 3 is illustrated in detail hereinafter with reference to the accompanying drawings. As shown in FIG. 2, a horizontal axis as shown in FIG. 2 represents a time, and blocks on the time axis represent all alike alarms, as shown in FIG. 2, which are an alike alarm 1, an alike alarm 2, an alike alarm 3, an alike alarm X, an alike alarm 4, and an alike alarm 5 respectively in a time sequence. Two sides of each block perpendicular to the time axis represent alarm generation and alarm clearance for the current alike alarm respectively, so the span of Block 1 on the time axis represents the generation duration of the alike alarm 1, and the gap between Block 1 and Block 2 on the time axis represents the alarm clearance duration of the alike alarm 1.

TW1 represents the width of the previous sliding time window, TW2 represents the width of the next sliding time window, T_{upedge} represents an upper edge of a sliding time window, T_{loweredge} represents a lower edge of a sliding time window, TT1 represents an alarm generation notification sending threshold, TT2 represents an alarm clearance notification sending threshold, F(t) represents an alarm generation duration of an alike alarm, and F( t̅) re presents an alarm clearance duration of an alike alarm.

As shown in FIG. 2, the alarm generation time tₓ of the alike alarm X is used as the upper edge time T_{upedge} of the previous sliding time window TW1, and T_{upedge}−TW₁ is used as the lower edge time T_{loweredge} of the previous sliding time window TW1. The obtaining the alike alarm duration accumulation information in the appointed period determined by the previous sliding time window is to obtain a sum ΣF(t) of an alarm generation duration of the alike alarm 1, the alike alarm 2, and the alike alarm 3 occurring in the TW1. If ΣF(t) ≧TT1, it indicates that the alike alarm duration accumulation information satisfies the alarm generation notification sending condition, so the alarm generation notification is reported. The alarm generation time of the alike alarm X being selected as the upper edge of the previous sliding time window TW1 in this embodiment is only exemplary, a generation time of other alike alarms, or a clearance time of an alike alarm, or a certain time point in an alike alarm generation duration, or a certain time point in an alike alarm clearance duration may also be selected, and the embodiment of the present invention is not limited in terms of the alarm generation time of the alike alarm X.

When the alike alarm duration accumulation information obtained at tₓ does not satisfy the alarm generation notification sending condition, further, the previous sliding time window is moved, and the alike alarm duration accumulation information is obtained again. For example, the upper edge time of the previous sliding time window is moved to the time point t_{y}, t_{y} is used as the upper edge time T_{upedge} of the previous sliding time window, T_{upedge}−TW₁ is used as the lower edge time T_{loweredge} of the previous sliding time window, and the alike alarm generation duration accumulation information occurring in the moved previous sliding time window TW1 is obtained, that is, if ΣF(t). ΣF(t)≧TT1, it indicates that the alike alarm duration accumulation information satisfies the alarm generation notification sending condition, so the alarm generation notification is reported.

The alarm clearance time t_{z} of the alike alarm X is used as the lower edge time T_{loweredge} of the next sliding time window TW2, T_{lowedge}+TW₂ is used as the upper edge time T_{upedge} of the next sliding time window TW2, and the alike alarm generation duration accumulation information in the appointed period determined by the next sliding time window is obtained, which is for example, a sum ΣF(t) of all alike alarm generation durations occurring in TW2. If ΣF(t)≦TT2, it indicates that the alike alarm duration accumulation information satisfies the alarm clearance notification sending condition, so the alarm clearance notification is sent. Particularly, the alarm clearance time t_{z} of the alike alarm X may also be used as the lower edge time T_{loweredge} of the next sliding time window TW2, and T_{lowedge}+TW2 is used as the upper edge time T_{upedge} of the next sliding time window TW2. If no alike alarm occurs in the period determined by the next sliding time window, that is, a sum of the alike alarm generation durations is 0, the alarm clearance notification is sent.

When the alike alarm duration accumulation information obtained at t_{z} does not satisfy the alarm clearance notification sending condition, further, the next sliding time window may be moved, and the alike alarm duration accumulation information is obtained again. When the alike alarm duration accumulation information in the moved next sliding time window satisfies the alarm clearance notification sending condition, the alarm clearance notification is sent.

The method for moving the sliding time window may be moving with equal intervals in terms of time, for example, moving 1 second every time, and the alike alarm duration accumulation information in the moved time window is calculated. The method for moving the sliding time window may also be moving with unequal intervals, and of course, a combination of the two manners may be adopted. For example, in a first step, a difference value Δₜ(Δₜ is a difference value between the alarm notification generation threshold and the alike alarm accumulation time in TW1) is moved back from a generation time point tₓ of an alike alarm, and the alike alarm duration accumulation information is calculated. If the alike alarm duration accumulation information does not satisfy the threshold of the report alarm notification, then it is evenly moved at a step of 1 second. The foregoing method for moving the sliding time window is only exemplary, and the embodiment of the present invention is not limited in terms of the method for moving the sliding time window.

The specific implementation of Manners 2 and 4 is similar to that of Manners 1 and 3, and the difference is that the alike alarm clearance duration accumulation information in the appointed period is obtained and compared with the corresponding threshold, the description of which is omitted here.

The threshold value and the report condition in the embodiment of the present invention are only exemplary, the embodiment of the present invention is not limited in terms of the threshold value and the report condition, and a reasonable threshold value may be set as the report condition according to practical situations.

Alarm information reported by the failure detection device is received, alike alarm duration accumulation information in an appointed period is obtained from the reported alarm information, and an alarm notification is sent when the alike alarm duration accumulation information satisfies a report condition, so the alarm processing method according to the present invention can adapt to a failure mode with a characteristic of changing with time and be independently implemented, filter valuable alarm information correctly and timely for alarms generated by an unstable failure, a stable failure, a failure with a long or short duration, and ensure stable operation of a communication equipment. Meanwhile, in the method according to the embodiment of the present invention, the alike alarm duration accumulation information in the appointed period is obtained, so the method may also effectively reduce a quantity of the alarm information, and acquire a very good balance between the quantity of alarms and the correctness as well as the timeliness of alarms.

In an embodiment, the present invention further provides an alarm processing system, and the system includes a failure detection device and an alarm processing device.

The failure detection device is configured to detect a failure and report alarm information to the alarm processing device when the failure is detected.

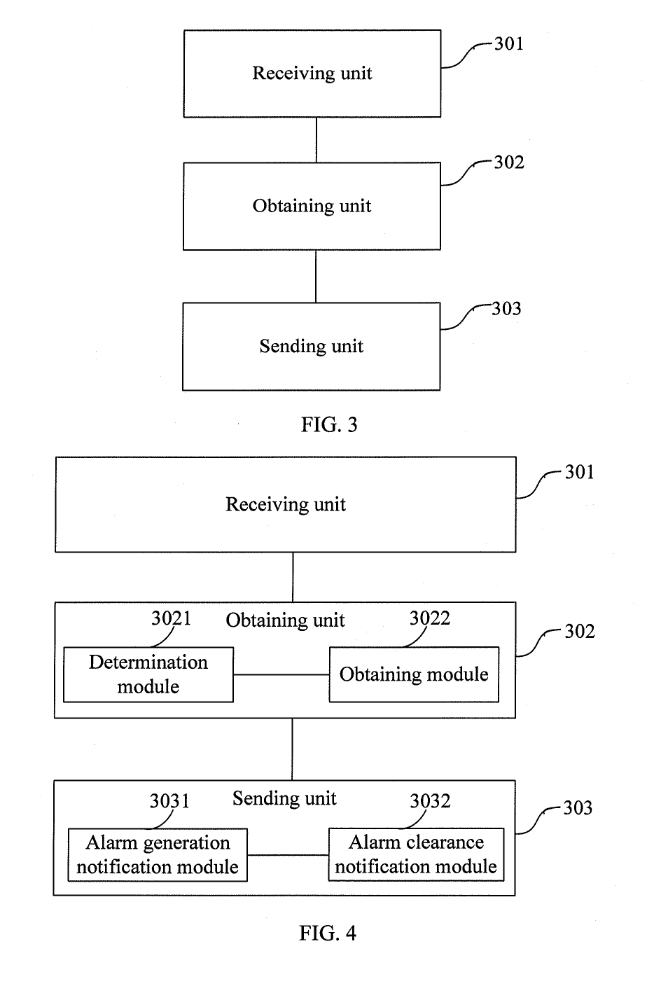

As shown in FIG. 3, the alarm processing device includes a receiving unit 301, an obtaining unit 302, and a sending unit 303.

The receiving unit 301 is configured to receive reported alarm information.

The obtaining unit 302 is configured to obtain alike alarm duration accumulation information in an appointed period according to the alarm information received by the receiving unit.

The sending unit 303 is configured to send an alarm notification when the alike alarm duration accumulation information in the appointed period obtained by the obtaining unit satisfies a report condition.

The appointed period may be a period determined by an upper edge time and a lower edge time of a sliding time window, and the sliding time window moves with time. The alike alarm duration accumulation information in the appointed period includes: alike alarm generation duration accumulation information in the appointed period or alike alarm clearance duration accumulation information in the appointed period.

Specifically, as shown in FIG. 4, the sending unit 303 may include an alarm generation notification module 3031 and an alarm clearance notification module 3032.

The alarm generation notification module 3031 is configured to send an alarm generation notification when the alike alarm duration accumulation information in the appointed period satisfies an alarm generation notification sending condition; and/or,

The alarm clearance notification module 3032 is configured to send an alarm clearance notification when the alike alarm duration accumulation information in the appointed period satisfies an alarm clearance notification sending condition.

Specifically, the obtaining unit 302 may include a determination module 3021 and an obtaining module 3022.

The determination module 3021 is configured to determine the appointed period.

Additionally, the determination module is configured to determine a period between an upper edge time and a lower edge time of a sliding time window.

The acquiring module 3022 is configured to obtain alike alarm duration accumulation information in a period determined by the determining module.

The specific procedure of applying the device and the system according to the embodiment of the present invention to realize alarm processing is basically similar to that in the foregoing method embodiment, the description of which is omitted here.

Alike alarm duration accumulation information in an appointed period is obtained, and an alarm notification is sent when the alike alarm duration accumulation information satisfies a report condition, so the alarm processing device and system provided in the embodiments of the present invention can adapt to a failure mode with a characteristic of changing with time and be independently implemented, filter valuable alarm information correctly and timely for alarms generated by an unstable failure, a stable failure, a failure with a long or short duration, and ensure stable operation of a communication equipment. Meanwhile, according to the embodiment of the present invention, the alike alarm duration accumulation information in the appointed period is obtained, so the method can also effectively reduce a quantity of alarm information, and acquire a very good balance between a quantity of alarms and correctness as well as timeliness of alarms.

Through the descriptions of the preceding embodiments, persons skilled in the art may understand that the present invention may be implemented by hardware only or by software and a necessary universal hardware platform. However, in most cases, using software and a necessary universal hardware platform are preferred. Based on such understandings, all or part of the technical solution under the present invention that makes contributions to the prior art may be essentially embodied in the form of a software product. The software product may be stored in a storage medium, which can be a magnetic disk, a Compact Disk Read-Only Memory (CD-ROM), a Read-Only Memory (ROM) or a Random Access Memory (RAM). The software product includes a number of instructions that enable a computer device (a personal computer, a server, or a network device) to execute the methods provided in the embodiments of the present invention.

The above descriptions are merely some exemplary embodiments of the present invention, but not intended to limit the scope of the present invention. Any modification, equivalent replacement, or improvement made without departing from the spirit and principle of the present invention should fall within the scope of the present invention. Therefore, the protection scope of the present invention is subject to the appended claims.

1. An alarm processing method, comprising:
receiving alarm information reported when a failure is detected;
obtaining alike alarm duration accumulation information in an appointed period according to the received alarm information; and
sending an alarm notification when the alike alarm duration accumulation information in the appointed period satisfies a report condition.

2. The method according to claim 1, wherein the sending the alarm notification when the alike alarm duration accumulation information in the appointed period satisfies the report condition comprises:
sending an alarm generation notification when the alike alarm duration accumulation information in the appointed period satisfies an alarm generation notification sending condition.

3. The method according to claim 2, wherein the alarm generation notification sending condition or the alarm clearance notification sending condition comprises a threshold value.

4. The method according to claim 1, wherein the obtaining the alike alarm duration accumulation information in the appointed period comprises:
determining an upper edge and a lower edge of a sliding time window, and obtaining alike alarm duration accumulation information in a period between an upper edge time and a lower edge time of the sliding time window.

5. The method according to claim 4, wherein the lower edge time of the sliding time window is determined as a clearance time of an alike alarm.

6. The method according to claim 4, wherein the method further comprises:
moving the sliding time window when the alike alarm duration accumulation information in the appointed period does not satisfy a report condition;
obtaining the alike alarm duration accumulation information in the moved sliding time window; and
sending an alarm notification when the alike alarm duration accumulation information in the moved sliding time window satisfies a report condition.

7. The method according to claim 1, wherein the obtaining the alike alarm duration accumulation information in the appointed period comprises:
obtaining alike alarm generation duration accumulation information in the appointed period.

8. An alarm processing device, comprising:
a receiving unit, configured to receive reported alarm information;
an obtaining unit, configured to obtain alike alarm duration accumulation information in an appointed period according to the alarm information received by the receiving unit; and
a sending unit, configured to send an alarm notification when the alike alarm duration accumulation information in the appointed period obtained by the obtaining unit satisfies a report condition.

9. The alarm processing device according to claim 8, wherein the sending unit comprises:
an alarm generation notification module, configured to send an alarm generation notification when the alike alarm duration accumulation information in the appointed period satisfies an alarm generation notification sending condition.

10. The alarm processing device according to claim 8, wherein the obtaining unit comprises:
a determination module, configured to determine the appointed period; and
an obtaining module, configured to obtain alike alarm duration accumulation information in the period determined by the determining module.

11. The alarm processing device according to claim 10, wherein the determination module is configured to determine a period between an upper edge time and a lower edge time of a sliding time window.

12. The alarm processing device according to claim 8, wherein the alike alarm duration accumulation information in the appointed period comprises:
alike alarm generation duration accumulation information in the appointed period.

13. An alarm processing system, comprising: a failure detection device and an alarm processing device, wherein
the failure detection device is configured to detect a failure and report alarm information to the alarm processing device when the failure is detected; and
the alarm processing device is configured to receive the reported alarm information, obtain alike alarm duration accumulation information in an appointed period according to the reported alarm information, and send an alarm notification when the alike alarm duration accumulation information in the appointed period satisfies a report condition.

14. The alarm processing system according to claim 13, wherein the alike alarm duration accumulation information in the appointed period comprises:
alike alarm generation duration accumulation information in the appointed period.

15. The method according to claim 1, wherein the sending the alarm notification when the alike alarm duration accumulation information in the appointed period satisfies the report condition comprises:
sending an alarm clearance notification when the alike alarm duration accumulation information in the appointed period satisfies an alarm clearance notification sending condition.

16. The method according to claim 15, wherein the alarm generation notification sending condition or the alarm clearance notification sending condition comprises a threshold value.

17. The method according to claim 1, wherein the obtaining the alike alarm duration accumulation information in the appointed period comprises:
obtaining alike alarm clearance duration accumulation information in the appointed period.

18. The alarm processing device according to claim 8, wherein the sending unit comprises:
an alarm clearance notification module, configured to send an alarm clearance notification when the alike alarm duration accumulation information in the appointed period satisfies an alarm clearance notification sending condition.

19. The alarm processing device according to claim 8, wherein the alike alarm duration accumulation information in the appointed period comprises:
alike alarm clearance duration accumulation information in the appointed period.

20. The alarm processing system according to claim 13, wherein the alike alarm duration accumulation information in the appointed period comprises:
alike alarm clearance duration accumulation information in the appointed period.
